(19) United States
(12) Patent Application Publication
(10) Pub. No.: US 2025/0358772 A1
(43) Pub. Date: Nov. 20, 2025

(54) POSITIONING IN A MOBILE COMMUNICATION SYSTEM

(71) Applicant: Nokia Technologies Oy, Espoo (FI)

(72) Inventors: Johannes HARREBEK, Aalborg (DK); Oana-Elena BARBU, Aalborg (DK); Benny VEJLGAARD, Aalborg (DK); Nuno Manuel KIILERICH PRATAS, Aalborg (DK); Jan Torst HVIID, Aalborg (DK); Prajwal KESHAVAMURTHY, Munich (DE)

(21) Appl. No.: 18/854,371

(22) PCT Filed: Apr. 5, 2022
(86) PCT No.: PCT/EP2022/058928

§ 371 Date: Oct. 4, 2024

(51) Int. Cl. H04W 64/00; G01S 13/87

(52) U.S. Cl. CPC H04W 64/00; G01S 13/878

(57) ABSTRACT

An apparatus, method and computer program are disclosed relating to positioning in a mobile communication system. One operation of the method may comprise receiving, by a target device of a mobile communications network, reference data from each of a plurality of nodes associated with a first positioning session, the reference data from a particular node representing the position of the particular node. Another operation may comprise determining, by the target device, for each of a plurality of pairs of the nodes, whether first and second nodes of the pair are collinear based at least in part on the reference data from the first and second nodes. Another operation may comprise, responsive to determining that at least one of the pairs has collinear first and second nodes, adding of one or more new nodes, not associated with the first positioning session, to a subsequent positioning session with at least some nodes of the first positioning session, wherein the nodes are configured to transmit positioning signals to the target device for the target device to determine its own position.

### FIELD

The present specification relates to positioning in mobile communication systems.

### BACKGROUND

The use of positioning signals for determining a position of fixed and mobile nodes of a mobile communication system is known. However, there remains a need for further improvements in this field.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus comprising means for: apparatus comprising means for performing: receiving, by a target device of a mobile communications network, reference data from each of a plurality of nodes associated with a first positioning session, the reference data from a particular node representing the position of the particular node; determining, by the target device, for each of a plurality of pairs of the nodes, whether first and second nodes of the pair are collinear based at least in part on the reference data from the first and second nodes; and responsive to determining that at least one of the pairs has collinear first and second nodes, adding of one or more new nodes, not associated with the first positioning session, to a subsequent positioning session with at least some nodes of the first positioning session, wherein the nodes are configured to transmit positioning signals to the target device for the target device to determine its own position.

The apparatus may further comprise means for determining, for each pair of the nodes, a first distance (L1) between the first and second nodes based on the received reference data from a first and second nodes, a second distance (L2) between the target device and the first node, and a third distance (L3) between the target device and the second node, wherein determining whether the first and second nodes of the pair are collinear is based on the first, second and third distances (L1, L2, L3).

Collinearity may be determined for a particular pair of the nodes if:

$${L}_{1} \approx {L}_{3} - {L}_{2} , or$$

$${L}_{1} \approx {L}_{2} + {L}_{3} .$$

Collinearity may be determined for a particular pair of the nodes if:

$$\begin{matrix}a \leq {a}_{m} , or \\ \vert ( a - 180 ) \vert \leq {a}_{m}\end{matrix}$$

where α is the angle, in degrees, between directions of the first and second nodes of the particular pair from the target device and aₘ is a predetermined threshold.

The value α may be determined by:

$$a = a cos ( \frac{{( L 2 )}^{2} + {( L 3 )}^{2} - {( L 1 )}^{2}}{2 * L 2 * L 3} )$$

The plurality of nodes may be user devices of a mobile communications network.

The positioning signals and/or reference data may be communicated over respective sidelinks between the target device and the plurality of nodes.

The apparatus may further comprise means for performing, by the target device, a sidelink discovery process for identifying the plurality of nodes based on their proximity to the target device and for establishing the sidelink between the target device and each of the plurality of nodes.

The reference data from a particular node of the plurality of nodes may represent absolute position coordinates of the particular node.

The second and third distances (L2, L3) may be determined based on respective ranging signals, transmitted by the target device, to the first and second nodes of a particular pair of nodes.

The second and third distances (L2, L3) may be determined based on a round-trip time (RTT) measurement from transmitting the respective ranging signals to the first and second nodes and receiving therefrom responsive reference signals.

The apparatus may further comprise means for re-performing the determining and adding operations for nodes of the subsequent positioning session until at least three non-collinear nodes are identified.

The apparatus may further comprise means for determining an updated position of the target device based on received positioning signals from at least three non-collinear nodes.

A prior position of the target device based on nodes associated with the first positioning session may be assigned a first weight W₁ and the updated position of the target device based on nodes associated with the subsequent positioning session may be assigned a second weight W₂>W₁, in which case the apparatus may be further configured to generate a position of the target device based on a weighted combination of the prior and updated positions.

The apparatus may be the target device.

The means may comprise: at least one processor; and at least one memory including computer program code, the at least one memory and computer program code configured to, with the at least one processor, cause the performance of the apparatus.

According to a second aspect, there is described a method comprising: receiving, by a target device of a mobile communications network, reference data from each of a plurality of nodes associated with a first positioning session, the reference data from a particular node representing the position of the particular node; determining, by the target device, for each of a plurality of pairs of the nodes, whether first and second nodes of the pair are collinear based at least in part on the reference data of the first and second nodes; and responsive to determining that at least one of the pairs has collinear first and second nodes, causing adding of one or more new nodes, not associated with the first positioning session, to a subsequent positioning session with at least some nodes of the first positioning session, wherein the nodes are configured to transmit positioning signals to the target device for the target device to determine its own position.

The method may further comprise determining, for each pair of the nodes, a first distance (L1) between the first and second nodes based on the received reference data from a first and second nodes, a second distance (L2) between the target device and the first node, and a third distance (L3) between the target device and the second node, wherein determining whether the first and second nodes of the pair are collinear is based on the first, second and third distances (L1, L2, L3).

Collinearity may be determined for a particular pair of the nodes if:

$$\begin{matrix}{L}_{1} \approx {L}_{3} - {L}_{2} , or \\ {L}_{1} \approx {L}_{2} + {L}_{3} .\end{matrix}$$

Collinearity may be determined for a particular pair of the nodes if:

$$\begin{matrix}a \leq {a}_{m} , or \\ \vert ( a - 180 ) \vert \leq {a}_{m}\end{matrix}$$

where α is the angle, in degrees, between directions of the first and second nodes of the particular pair from the target device and aₘ is a predetermined threshold.

The value α may be determined by:

$$a = a cos ( \frac{{( L 2 )}^{2} + {( L 3 )}^{2} - {( L 1 )}^{2}}{2 * L 2 * L 3} )$$

The plurality of nodes may be user devices of a mobile communications network.

The positioning signals and/or reference data may be communicated over respective sidelinks between the target device and the plurality of nodes.

The method may further comprise performing, by the target device, a sidelink discovery process for identifying the plurality of nodes based on their proximity to the target device and for establishing the sidelink between the target device and each of the plurality of nodes.

The reference data from a particular node of the plurality of nodes may represent absolute position coordinates of the particular node.

The second and third distances (L2, L3) may be determined based on respective ranging signals, transmitted by the target device, to the first and second nodes of a particular pair of nodes.

The second and third distances (L2, L3) may be determined based on a round-trip time (RTT) measurement from transmitting the respective ranging signals to the first and second nodes and receiving therefrom responsive reference signals.

The method may further comprise re-performing the determining and adding operations for nodes of the subsequent positioning session until at least three non-collinear nodes are identified.

The method may further comprise determining an updated position of the target device based on received positioning signals from at least three non-collinear nodes.

A prior position of the target device based on nodes associated with the first positioning session may be assigned a first weight W₁ and the updated position of the target device based on nodes associated with the subsequent positioning session may be assigned a second weight W₂>W₁, in which case the method may comprise generating a position of the target device based on a weighted combination of the prior and updated positions.

The method may be performed by the target device.

According to a third aspect, there is provided a computer program product comprising a set of instructions which, when executed on an apparatus, is configured to cause the apparatus to carry out the method of: receiving, by a target device of a mobile communications network, reference data from each of a plurality of nodes associated with a first positioning session, the reference data from a particular node representing the position of the particular node; determining, by the target device, for each of a plurality of pairs of the nodes, whether first and second nodes of the pair are collinear based at least in part on the reference data of the first and second nodes; and responsive to determining that at least one of the pairs has collinear first and second nodes, causing adding of one or more new nodes, not associated with the first positioning session, to a subsequent positioning session with at least some nodes of the first positioning session, wherein the nodes are configured to transmit positioning signals to the target device for the target device to determine its own position.

According to a fourth aspect, there is provided a non-transitory computer readable medium comprising program instructions stored thereon for performing a method, comprising: receiving, by a target device of a mobile communications network, reference data from each of a plurality of nodes associated with a first positioning session, the reference data from a particular node representing the position of the particular node; determining, by the target device, for each of a plurality of pairs of the nodes, whether first and second nodes of the pair are collinear based at least in part on the reference data of the first and second nodes; and responsive to determining that at least one of the pairs has collinear first and second nodes, causing adding of one or more new nodes, not associated with the first positioning session, to a subsequent positioning session with at least some nodes of the first positioning session, wherein the nodes are configured to transmit positioning signals to the target device for the target device to determine its own position.

According to a fifth aspect, there is provided an apparatus comprising: at least one processor; and at least one memory including computer program code which, when executed by the at least one processor, causes the apparatus: to receive, by a target device of a mobile communications network, reference data from each of a plurality of nodes associated with a first positioning session, the reference data from a particular node representing the position of the particular node; to determine, by the target device, for each of a plurality of pairs of the nodes, whether first and second nodes of the pair are collinear based at least in part on the reference data of the first and second nodes; and responsive to determining that at least one of the pairs has collinear first and second nodes, to cause adding of one or more new nodes, not associated with the first positioning session, to a subsequent positioning session with at least some nodes of the first positioning session, wherein the nodes are configured to transmit positioning signals to the target device for the target device to determine its own position.

### BRIEF DESCRIPTION OF DRAWINGS

Example embodiments will now be described by way of non-limiting example, with reference to the accompanying drawings, in which:

FIG. 1 is a block diagram of a system in accordance with an example embodiment.

FIG. 2A is a block diagram of a first system scenario, based on FIG. 1;

FIG. 2B is a block diagram of a second system scenario, based on FIG. 1;

FIG. 3 is a block diagram of a third system scenario for determining collinearity in accordance with an example embodiment, based on FIG. 1;

FIG. 4 is a schematic view of the third system scenario for determining collinearity;

FIGS. 5A, 5B and 5C are respective block diagrams of other system scenarios, based on FIG. 1;

FIG. 6 is a flow diagram showing processing operations in accordance with an example embodiment;

FIG. 7 is a flow diagram showing processing operations in accordance with another example embodiment;

FIG. 8 is a sequence diagram according to an example embodiment;

FIG. 9 is an apparatus that may implement one or more example embodiments; and

FIG. 10 is a non-transitory medium that may store or carry computer-readable code that, when executed on an apparatus such as that of FIG. 9, may implement one or more example embodiments.

### DETAILED DESCRIPTION

Example embodiments relate to positioning in a mobile communications system.

In a mobile communications system, it may be important to determine the position of a target device that may change position. For example, the target device may be a user equipment (UE) such as a smartphone, laptop, tablet computer, wearable device or even a vehicle. Knowing the position of the UE may be useful for optimization of radio resources, provision of location-based services, guidance and/or alert generation, to give some examples. The 3rd Generation Partnership Project (3GPP) has developed various standards and proposals relating to positioning of target devices via various methods based on, for example, fourth and fifth generation (4G and 5G) radio access technologies (RATs) and also future RATs. Some positioning techniques rely on the target device communicating with nodes having respective known positions. The position of the target device may be determined based on the range of the target device from at least three of the nodes using multilateration methods.

In this context, example embodiments may relate to, inter alia, an apparatus, method and computer program for determining collinearity of first and second nodes of a plurality of nodes in a positioning session, which nodes provide positioning signals to a target device. One or more other nodes may be added to the plurality of nodes in the event of determined collinearity for the purposes of increasing positional accuracy.

The term “target UE” will be used hereafter on the assumption that it is the position of a UE we are interested in. However, example embodiments are applicable to any form of target device.

In some example embodiments, at least some of the nodes which provide the positioning signals to the target UE are other UEs which communicate with the target UE using so-called sidelink connections, or “sidelinks.”

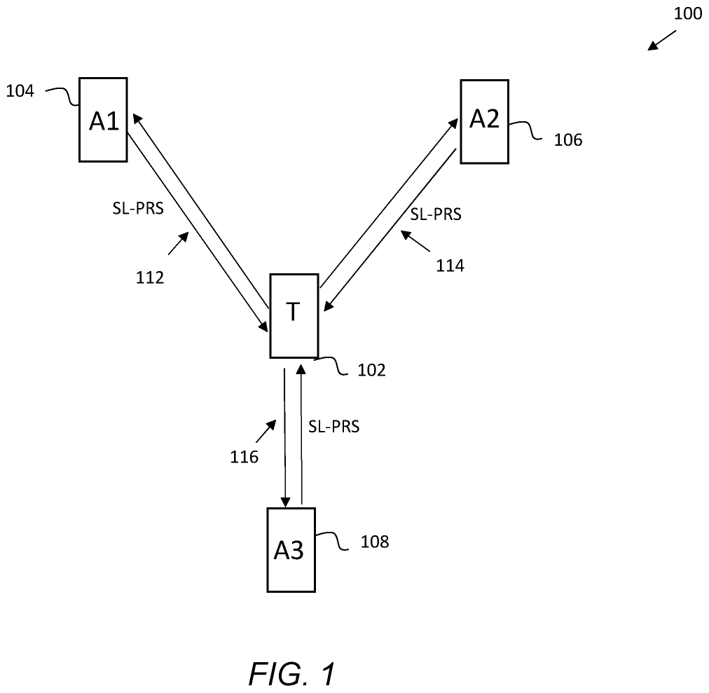

FIG. 1 is a block diagram of a system, indicated generally by the reference numeral 100, in accordance with an example embodiment.

The system 100 may comprise a target UE 102 which may be configured, in accordance with some example embodiments, to determine its own position using positioning signals received from three or more other UEs which may be referred to as anchor UEs. In the shown example, there are first, second and third anchor UEs 104, 106, 108.

The target UE 102 may, for example, be a smartphone, laptop, tablet computer, wearable device or even a vehicle. The first, second and third anchor UEs 104, 106, 108 may also be any form of UE with known positions in order that the target UE 102 may determine its own position using multilateration methods.

The target UE 102 may communicate with the first, second and third anchor UEs 104, 106, 108 using respective sidelinks 112, 114, 116. The use of so-called “sidelinks” for direct communications between UEs without the need for signals to go via a base station are proposed in 3GPP release 12. New Radio (NR) sidelinks are introduced in 3GPP release 16 and, in relation to positioning, in 3GPP release 18. Sidelinks employ a so-called PC5 interface between pairs of UEs.

Initially, the target UE 102 may initiate a positioning session in order to determine its own position using positioning signals from three or more anchor UEs that will be part of (or are associated with) the positioning session. This may be self-triggered or triggered by some external event or device.

The target UE 102 may perform a sidelink discovery procedure. For example, the sidelink discovery procedure may involve the target UE 102 broadcasting a request, e.g. a discovery solicitation request, comprising an indication of what the target UE 102 wants to discover. For example, the discovery solicitation request may include a proximity services (ProSe) application identifier and an indication that the target UE 102 wishes to receive positioning signals. Effectively, the discovery solicitation request may comprise any suitable request that asks other proximate UEs to become anchor UEs for a positioning session.

Nearby UEs, such as the first, second and third anchor UEs 104, 106, 108 may respond to accept the request, on the basis that they are proximate to the target UE 102 and can provide positioning signals to the target UE 102. The first, second and third anchor UEs 104, 106, 108 become part of the positioning session and data can be exchanged using respective sidelinks 112, 114, 116 which are established at this point.

In other scenarios, there may be more than three anchor UEs. The first, second and third anchor UEs 104, 106, 108 may have different positions to those shown and these may change over time.

For example, each of the first, second and third anchor UEs 104, 106, 108 may transmit over respective sidelinks 112, 114, 116 reference data comprising their own position (i.e. their absolute position in any suitable form, e.g. coordinates) as part of the acceptance procedure mentioned above, or at a later time. Each of the first, second and third anchor UEs 104, 106, 108 may also transmit over respective sidelinks 112, 114, 116 positioning reference signals (PRS) or similar. The notation SL-PRS in FIG. 1 indicates the use of sidelinks 112, 114, 116 to provide the PRSs. The target UE 102 may determine its own range or distance from each of the first, second and third anchor UEs 104, 106, 108 using conventional methods based on the received PRS, e.g. using round-trip time (RTT) methods.

With a range estimate from, and knowledge of the position of, each of the first, second and third anchor UEs 104, 106, 106, multilateration can be used to estimate the position of the target UE 102 with a reasonable amount of accuracy.

In some cases, the first, second and third anchor UEs 104, 106, 108 may be static, e.g. they are fixed units, or one or more of the anchor UEs may be semi-static or may freely move. When two or more of the anchor UEs 104, 106, 108 become collinear from the point-of-view of the target UE 102, the target UE may experience so-called high geometric dilution of precision (GDOP) which reduces the accuracy of its position estimate. Collinear means that the two or more of the anchor UEs 104, 106, 108 are generally aligned when “seen” from the position of the target UE 102.

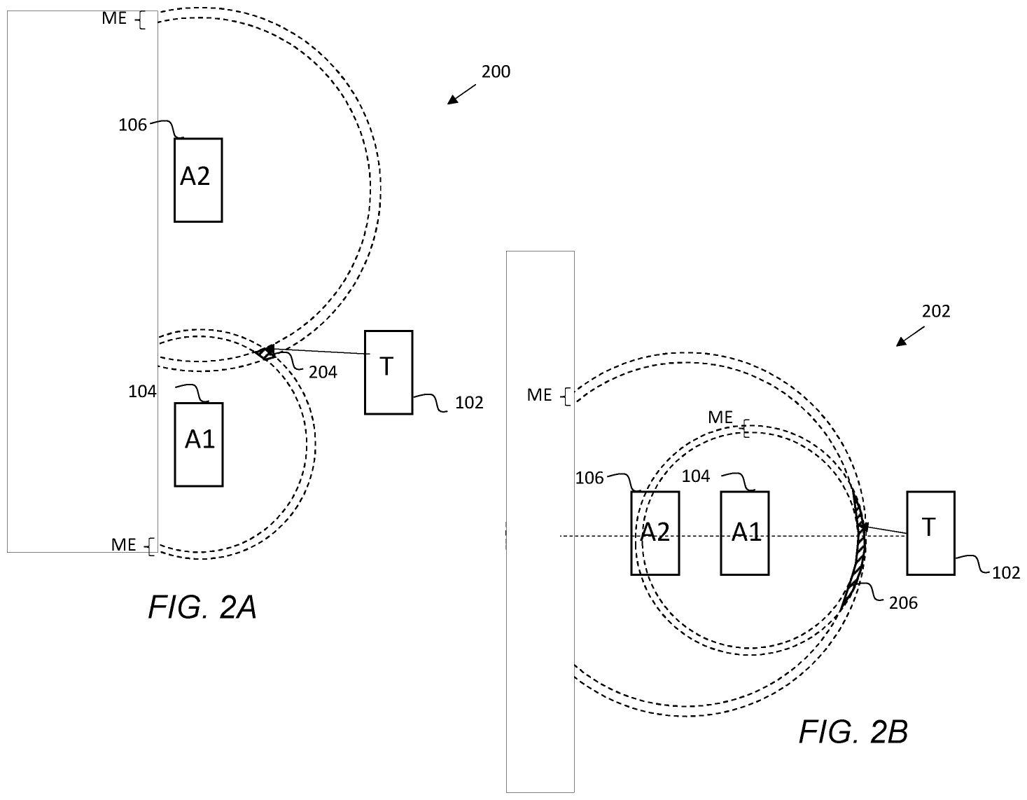

This issue is illustrated briefly with reference to FIGS. 2A and 2B.

FIG. 2A shows a scenario 200 in which the first and second anchor UEs 104, 106 are not collinear with the target UE 102. There will be a certain amount of measurement error (ME) for range, indicated by the dashed concentric circles that surround each of the first and second anchor UEs 104, 106. As such, it will be seen that the determined position of the target UE 102 will be somewhere within the shaded region 204. The shaded region 204 is relatively small and hence there is low GDOP. FIG. 2B shows a different scenario 202 where the first and second anchor UEs 104, 106 are collinear with the target UE 102. Here, due to this collinearity, the shaded region 206 is much larger and hence there is high GDOP. The positional accuracy will be lower.

Example embodiments aim to alleviate or overcome such issues by detecting, at the target UE 102, for each pair of nodes associated with a positioning session, whether the nodes of the pair are collinear or nearly collinear. In the FIG. 1 scenario 100 where there are first, second and third anchor UEs 104, 106, 108 (as examples of nodes) then there are three pairwise combinations. If one of these pairwise combinations is determined to be collinear, one or more new anchor UEs, e.g. a fourth anchor UE, may be added by the target UE 102 to the existing set of nodes as part of a new positioning session via the abovementioned discovery procedure. This may reduce GDOP and improve accuracy.

In some example embodiments, upon adding one or more new nodes, the process of determining collinearity can be re-performed.

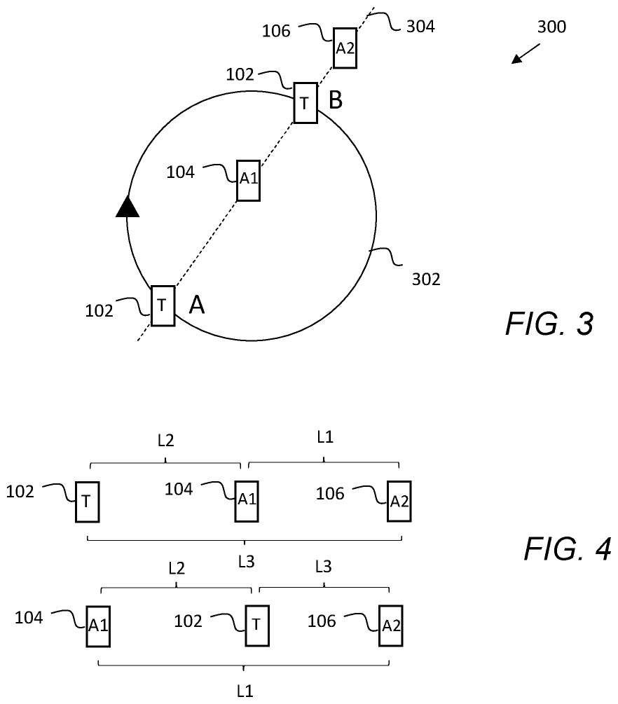

In terms of how to detect collinearity at the target UE 102, FIG. 3 shows a scenario 300 in which the target UE 102 moves along a circular path 302 relative to the first and second anchor UEs 104, 106. At positions indicated “A” and “B” it is seen that the first and second anchor UEs 104, 106 are collinear with respect to the target UE 102.

Turning to FIG. 4, top part, the arrangement of the target UE 102, the first anchor UE 104 and the second anchor UE 106 is shown when the target UE is in position “A”. A first distance (L1) is indicated between the first and second anchor UEs 104, 106, a second distance (L2) is indicated between the target UE 102 and the first anchor UE, and a third distance (L3) is indicated between the target UE and the second anchor UE. In this situation, it can be concluded that collinearity exists when:

$${L}_{1} \approx {L}_{3} - {L}_{2} \qquad ( 1 )$$

Turning to FIG. 4, bottom part, the arrangement of the target UE 102, the first anchor UE 104 and the second anchor UE 106 is shown when the target UE is in position “B”. Again, first, second and third distances (L1, L2, L3) are indicated. In this situation, it can be concluded that collinearity exists when:

$${L}_{1} \approx {L}_{2} + {L}_{3} \qquad ( 2 )$$

It follows that collinearity can be detected upon occurrence of condition (1) or condition (2).

A value of L1 can be determined by the target UE 102 based on the position data received from each of the first and second anchor UEs 104, 106 as part of the above sidelink discovery and acceptance process, or similar.

The values of L2 and L3 can be determined by the target UE 102 based on conventional ranging methods, e.g. RTT-based methods as mentioned above.

As such, it is possible for the target UE 102 to estimate using data and signals received over its sidelinks whether a given pair of nodes, such as the first and second UEs 104, 106 are collinear and therefore act accordingly.

In some example embodiments, the collinearity detection criteria above may be relaxed to account for measurement errors, estimation errors and/or noisy conditions. An angle-based approach may be used for this purpose, but one that still uses the values of L1, L2 and L3 which can be determined by the target UE 102.

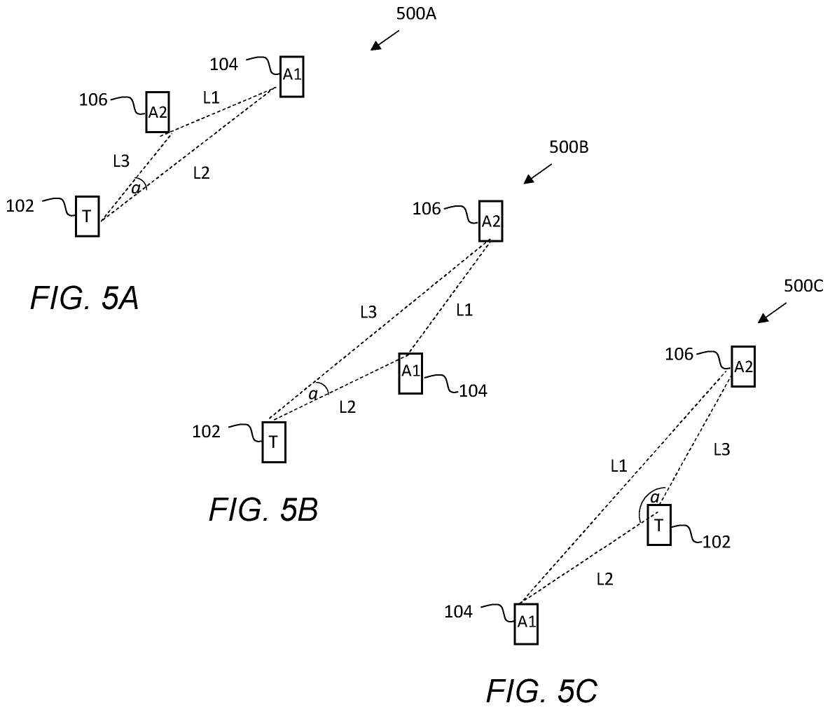

For example, FIGS. 5A, 5B and 5C show three different scenarios 500A, 500B, 500C in which the first and second anchor UEs 104, 106 are not collinear in the strict, geometric sense but may still result in high GDOP. We may still consider them to be collinear if certain conditions are met. This may be because the angle α between directions of the first and second anchor UEs 104, 106 from the target UE 102 is relatively small (as in the first and second scenarios 500A, 500B) or the angle α is relatively large, e.g. approaching 180 degrees (as in the third scenario 500C).

To detect collinearity based on angles, we can set a predetermined threshold “aₘ” and say that collinearity is determined for the first and second anchor UEs 104, 106 if:

$$\begin{matrix}a \leq {a}_{m} , or \\ \vert ( a - 180 ) \vert \leq {a}_{m}\end{matrix} \qquad ( 3 )$$

The value of aₘ may, for example, be set as 20 degrees or thereabouts, to give an example.

Note that degrees are used herein to measure angles and equivalent measures in radians could be used as an alternative.

The value of α may be determined at the target UE 102 using the formula:

$$a = a cos ( \frac{{( L 2 )}^{2} + {( L 3 )}^{2} - {( L 1 )}^{2}}{2 * L 2 * L 3} ) \qquad ( 4 )$$

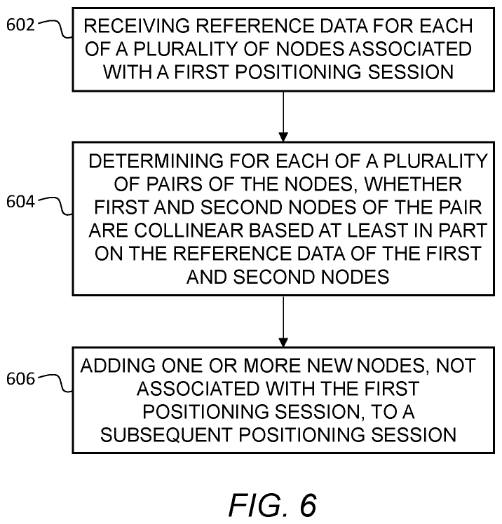

FIG. 6 is a flow diagram showing operations according to one or more example embodiments. The operations may be processing operations performed by hardware, software, firmware or a combination thereof.

A first operation 602 may comprise receiving reference data from each of a plurality of nodes associated with a first positioning session, the reference data from a particular node representing the position of the particular node.

A second operation 604 may comprise determining, for each of a plurality of pairs of the nodes, whether first and second nodes of the pair are collinear based at least in part on the reference data of the first and second nodes.

A third operation 606, performed responsive to determining that at least one of the pairs has collinear first and second nodes, may comprise adding of one or more new nodes, not associated with the first positioning session, to a subsequent positioning session with at least some nodes of the first positioning session.

The first, second and third operations 602, 604, 606 may be performed by a target device. The above target UE 102 is an example of a target device. The above first, second and third anchor UEs 104, 106, 108 are examples of “nodes” mentioned herein.

The subsequent positioning session may be a new positioning session or a new version of the first positioning session, depending on the implementation.

As used herein, the nodes may be configured to transmit positioning signals to the target device for the target device to determine its own position.

The second operation 604 may be performed using values of the first, second and third distances (L1, L2, L3) in respect of each pair of nodes. As noted, the target device may determine, for each pair of the nodes, a first distance (L1) between the first and second nodes of the pair based on the received reference data from the first and second nodes, a second distance (L2) between the target device and the first node, and a third distance (L3) between the target device and the second node.

Collinearity can be detected if any of conditions (1), (2) or (3) mentioned above are satisfied, depending on the implementation.

The positioning signals and/or reference data may be communicated between each node and the target device using a sidelink as defined above. This may include the target device performing a sidelink discovery process or procedure for identifying a plurality of nodes based on their proximity and for establishing respective sidelinks using known methods. The reference data referred to in the first operation 602 may represent absolute position coordinates of the particular node.

The second and third distances (L2, L3) may be determined based on respective ranging signals, transmitted by the target device, to the first and second nodes of a particular pair of nodes. For example, the second and third distances (L2, L3) may be determined based on a round-trip time (RTT) measurement from transmitting the respective ranging signals to the first and second nodes and receiving therefrom responsive reference signals.

In some example embodiments, the target device may be configured to re-perform the second operation 604 for nodes of the subsequent positioning session, and possibly the third operation 606, until at least three non-collinear nodes are identified.

In this context, non-collinearity may be satisfied if nodes have low collinearity, e.g. if condition (3) is used as the test.

At this time, the target device may determine an updated position based on received positioning signals from the at least three non-collinear nodes.

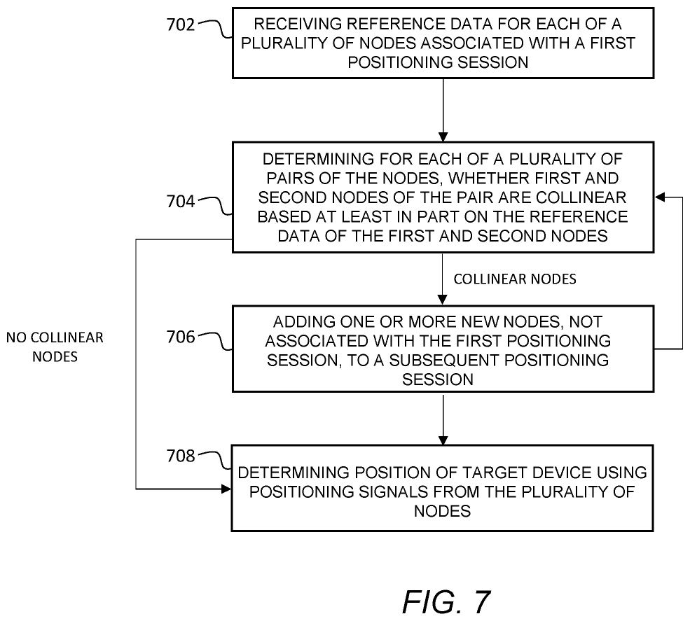

This may be illustrated with reference to FIG. 7.

Referring to FIG. 7, first, second and third operations 702, 704, 706 may correspond to the first, second and third operations 602, 604, 606 described with reference to FIG. 6.

As part of the first operation 702, it may be assumed, by way of example, that there are three nodes providing positioning signals to the target device as part of the first positioning session. The first positioning session may be established as part of the above-mentioned sidelink discovery process.

As part of the second operation 704, if none of the three pairwise combinations are determined to be collinear then the second operation may move to a fourth operation 708 of determining the position of the target device using positioning signals from the three nodes. If one or more of the three pairwise combinations is or are determined to be collinear, then the second operation 704 may move to the third operation 706 in which one or more new nodes may be added to a subsequent positioning session. For example, a fourth node may be added.

At this point, the third operation 706 may move to the fourth operation 708 of determining the position of the target device using positioning signals from the plurality of nodes, which now number four. Alternatively, one of the collinear nodes determined in the second operation 704 may not be used for the position determination; the one that is used may be that with the best receive signal quality or its location relative to the other existing nodes or that of the one or more new nodes. The use of four nodes may result in improved accuracy but there remains a possibility that the fourth node is collinear with one of the existing three nodes.

Alternatively or additionally, therefore, the third operation 706 may move back to the second operation 704 to re-perform the collinearity determination and the process may repeat as before.

In the case where the first positioning session involves more than three nodes, the second operation 704 may move to the fourth operation 708 if at least three nodes are not collinear. The fourth operation 708 may be performed using positioning signals from the at least three non-collinear nodes. Any node determined to be collinear with another node may not be used in the fourth operation 708.

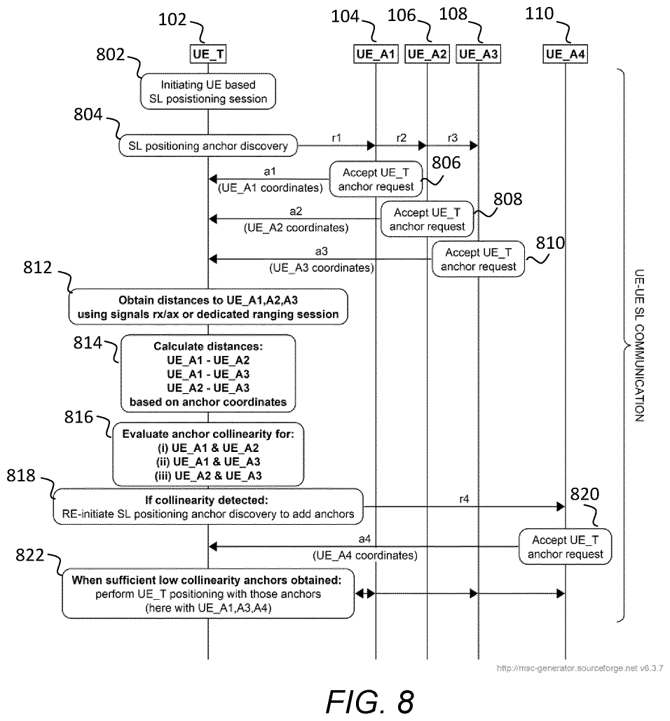

FIG. 8 is a sequence diagram according to example embodiments. Again, it may be assumed, by way of example, that there are three nodes providing positioning signals to the target device as part of the first positioning session. We may assume that the target device is the target UE 102 and the three nodes are the first, second and third anchor UEs 104, 106, 108 referred to previously.

A first operation 802 may comprise the target UE 102 (UE-T) initiating a UE-based sidelink (SL) positioning session using conventional processes. We may call this the first positioning session.

A second operation 804 may comprise performing a sidelink (SL) discovery process which involves the target UE 102 broadcasting a request (to act as positioning anchors) which may be received by the first, second and third anchor UEs 104, 106, 108.

In third to fifth operations 806, 808, 810 the first, second and third anchor UEs 104, 106, 108 may accept the request and transmit respective acceptance messages back to the target UE 102 with reference data comprising position coordinates.

In a sixth operation 812, the target UE 102 may determine respective distances or ranges from itself to the first, second and third anchor UEs 104, 106, 108 using, for example, RTT-based measurements or similar. This may comprise a dedicated ranging session.

In a seventh operation 814, the target UE 102 may determine distances between the resulting three pairwise combinations of the first, second and third anchor UEs 104, 106, 108 using the respective position coordinates:
first anchor UE 104 (UE_A1) & second anchor UE 106 (UE_A2);
first anchor UE 104 (UE_A1) & third anchor UE 108 (UE_A3); and
second anchor UE 106 (UE_A1) & third anchor UE 108 (UE_A2).

In an eighth operation 816, the target UE 102 may determine, or evaluate, collinearity for each of the above pairwise combinations using, for each pairwise combination, the values of the first, second and third distances (L1, L2, L3) and the conditions (1), (2) and/or (3) described above.

In a ninth operation 818, if collinearity is determined for one of the pairwise combinations, e.g. the first anchor UE 104 (UE_A1) and second anchor UE 106 (UE_A2), then the sidelink (SL) discovery process may be reinitiated by the target UE 102 for requesting another, in this case fourth anchor UE 110 (UE-A4), to join a subsequent positioning session.

In a tenth operation 820, the fourth anchor UE 110 may accept the request which is signalled back to the target UE 102 with its own reference data comprising position coordinates.

In an eleventh operation 822, the target UE 102 may perform positioning using positioning signals from non-collinear anchor UEs, in this case the first, third and fourth anchor UEs 104, 108, 110 (UE_A1, UE_A3, UE_A4) as part of the subsequent positioning session. This may be performed when at least three non-collinear anchor UEs are identified. In this case, positioning signals from the second anchor UE 106 are not used as part of the positioning process.

In some example embodiments, a position of the target UE 102 determined based on the first, second and third anchor UEs 104, 106, 108 (associated with the first positioning session) may be assigned a first weight W₁. The updated position of the target UE 102 based on the first, third and fourth anchor UEs 104, 108, 110 (associated with the subsequent positioning session) may be assigned a second weight W₂>W₁. The target UE 102 may be configured to generate a position of the target UE based on a weighted combination of the earlier and updated positions for improved accuracy.

Example embodiments therefore provide an apparatus, method and computer program for improved positioning by way of a target device identifying collinearity and updating a positioning session to include further nodes supplying positioning signals, thereby to overcome issues associated with high GDOP.

### Example Apparatus

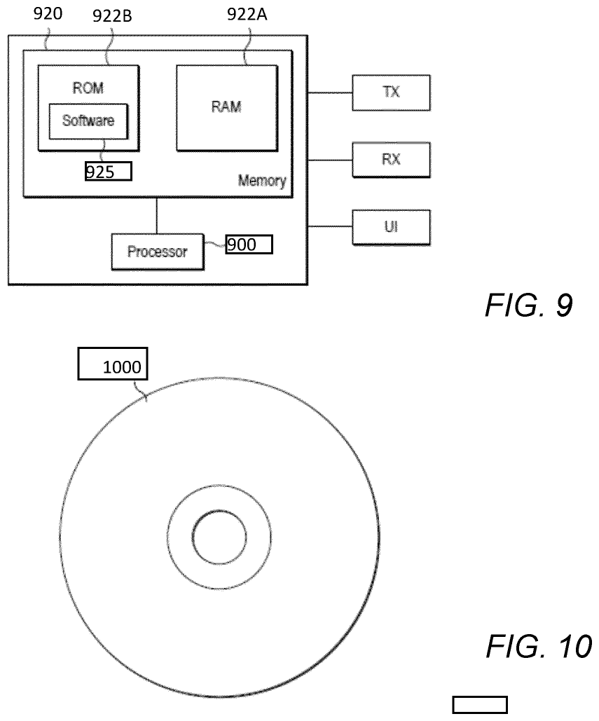

FIG. 9 shows an example apparatus. The apparatus may, for example, comprise the target UE 102 described above, or target device referred to in the claims.

The apparatus may comprise at least one processor 900 and at least one memory 910 directly or closely connected or coupled to the processor. The memory 910 may comprise at least one random access memory (RAM) 910a and at least one read-only memory (ROM) 910b. Computer program code (software) 920 may be stored in the ROM 910b. The apparatus may be connected to a transmitter path and a receiver path in order to obtain respective signals or data. The apparatus may be connected with a user interface (UI) for instructing the apparatus and/or for outputting data. The at least one processor 900 with the at least one memory 910 and the computer program code 920 may be arranged to cause the apparatus to at least perform methods described herein, such as those described with reference to FIGS. 6 and/or 7.

The processor 900 may be a microprocessor, plural microprocessors, a microcontroller, or plural microcontrollers.

The memory 910 may take any suitable form.

FIG. 10 shows a non-transitory media 1000 according to some embodiments. The non-transitory media 1000 is a computer readable storage medium. It may be e.g. a CD, a DVD, a USB stick, a blue ray disk, etc. The non-transitory media 1000 stores computer program code causing an apparatus to perform operations described above when executed by a processor such as processor 900 of FIG. 7.

Any mentioned apparatus and/or other features of particular mentioned apparatus may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus may be pre-programmed with the appropriate software to carry out desired operations, and wherein the appropriate software can be enabled for use by a user downloading a “key”, for example, to unlock/enable the software and its associated functionality. Advantages associated with such examples can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or examples may be incorporated in any other disclosed or described or suggested form or example as a general matter of design choice. Furthermore, in the claims means-plus-function clauses are intended to cover the structures described herein as performing the recited function and not only structural equivalents, but also equivalent structures.

The invention claimed is:

1. An apparatus comprising:
at least one processor; and
at least one memory storing instructions that, when executed by the at least one processor, cause the apparatus at least to perform:
receiving, by a target device of a mobile communications network, reference data from each of a plurality of nodes associated with a first positioning session, the reference data from a particular node representing the position of the particular node;
determining, by the target device, for each of a plurality of pairs of the nodes, whether first and second nodes of the pair are collinear based at least in part on the reference data from the first and second nodes; and
responsive to determining that at least one of the pairs has collinear first and second nodes, adding of one or more new nodes, not associated with the first positioning session, to a subsequent positioning session with at least some nodes of the first positioning session, wherein the nodes are configured to transmit positioning signals to the target device for the target device to determine its own position.

2. The apparatus of claim 1, wherein the apparatus is further caused to perform determining, for each pair of the nodes, a first distance (L1) between the first and second nodes based on the received reference data from a first and second nodes, a second distance (L2) between the target device and the first node, and a third distance (L3) between the target device and the second node, wherein determining whether the first and second nodes of the pair are collinear is based on the first, second and third distances (L1, L2, L3).

3. The apparatus of claim 2, wherein collinearity is determined for a particular pair of the nodes if:
$$\begin{matrix}{L}_{1} \approx {L}_{3} - {L}_{2} , or \\ {L}_{1} \approx {L}_{2} + {L}_{3} .\end{matrix}$$

4. The apparatus of claim 2, wherein collinearity is determined for a particular pair of the nodes if:
$$\begin{matrix}a \leq {a}_{m} , or \\ \vert ( a - 180 ) \vert \leq {a}_{m}\end{matrix}$$
where α is the angle, in degrees, between directions of the first and second nodes of the particular pair from the target device and aₘ is a predetermined threshold.

5. The apparatus of claim 4, wherein a is determined by:
$$a = a cos ( \frac{{( L 2 )}^{2} + {( L 3 )}^{2} - {( L 1 )}^{2}}{2 * L 2 * L 3} )$$

6. The apparatus of claim 1, wherein the plurality of nodes are user devices of a mobile communications network.

7. The apparatus of claim 6, wherein positioning signals and/or reference data are communicated over respective sidelinks between the target device and the plurality of nodes.

8. The apparatus of claim 7, wherein the apparatus is further caused to perform, by the target device, a sidelink discovery process for identifying the plurality of nodes based on their proximity to the target device and for establishing the sidelink between the target device and each of the plurality of nodes.

9. The apparatus claim 1, wherein the second and third distances (L2, L3) are determined based on respective ranging signals, transmitted by the target device, to the first and second nodes of a particular pair of nodes.

10. The apparatus of claim 9, wherein the second and third distances (L2, L3) are determined based on a round-trip time (RTT) measurement from transmitting the respective ranging signals to the first and second nodes and receiving therefrom responsive reference signals.

11. The apparatus of claim 1, wherein the apparatus is further caused to re-perform the determining and adding operations for nodes of the subsequent positioning session until at least three non-collinear nodes are identified.

12. The apparatus of claim 1, wherein the apparatus is further caused to perform determining an updated position of the target device based on received positioning signals from at least three non-collinear nodes.

13. The apparatus of claim 12, wherein a prior position of the target device based on nodes associated with the first positioning session is assigned a first weight W₁ and the updated position of the target device based on nodes associated with the subsequent positioning session is assigned a second weight W₂>W₁, wherein the apparatus is further configured to generate a position of the target device based on a weighted combination of the prior and updated positions.

14. The apparatus of claim 1, wherein the apparatus is the target device.

15. A method comprising:
receiving, by a target device of a mobile communications network, reference data from each of a plurality of nodes associated with a first positioning session, the reference data from a particular node representing the position of the particular node;
determining, by the target device, for each of a plurality of pairs of the nodes, whether first and second nodes of the pair are collinear based at least in part on the reference data of the first and second nodes; and
responsive to determining that at least one of the pairs has collinear first and second nodes, causing adding of one or more new nodes, not associated with the first positioning session, to a subsequent positioning session with at least some nodes of the first positioning session, wherein the nodes are configured to transmit positioning signals to the target device for the target device to determine its own position.

16. The method of claim 15, further comprising:
determining, for each pair of the nodes, a first distance (L1) between the first and second nodes based on the received reference data from a first and second nodes, a second distance (L2) between the target device and the first node, and a third distance (L3) between the target device and the second node, wherein determining whether the first and second nodes of the pair are collinear is based on the first, second and third distances (L1, L2, L3).

17. The method of claim 15, wherein collinearity is determined for a particular pair of the nodes if:
$$\begin{matrix}{L}_{1} \approx {L}_{3} - {L}_{2} , or \\ {L}_{1} \approx {L}_{2} + {L}_{3} .\end{matrix}$$

18. The method of claim 15, wherein collinearity is determined for a particular pair of the nodes if:
$$\begin{matrix}a \leq {a}_{m} , or \\ \vert ( a - 180 ) \vert \leq {a}_{m}\end{matrix}$$
where α is the angle, in degrees, between directions of the first and second nodes of the particular pair from the target device and aₘ is a predetermined threshold.

19. The method of claim 15, wherein a is determined by:
$$a = a cos ( \frac{{( L 2 )}^{2} + {( L 3 )}^{2} - {( L 1 )}^{2}}{2 * L 2 * L 3} )$$

20. The method of claim 15, wherein positioning signals and/or reference data are communicated over respective sidelinks between the target device and the plurality of nodes.
